(19) United States
(12) Patent Application Publication
(10) Pub. No.: US 2019/0026845 A1
(43) Pub. Date: Jan. 24, 2019

(54) Method and system for matching multi-tiered investors with real estate opportunities

(71) Applicant: Shilen Amin, New York, NY (US)

(72) Inventor: Shilen Amin, New York, NY (US)

(21) Appl. No.: 15/731,702

(22) Filed: Jul. 18, 2017

(51) Int. Cl. G06Q 50/16; G06Q 30/06

(52) U.S. Cl. CPC G06Q 50/16; G06Q 40/06; G06Q 30/06

(57) ABSTRACT

A method for selling real estate includes organizing prospective buyers into three tiers of investors; presenting real estate for sale only to investors in the first tier for a first period of time; if an investor in the first tier does not present an offer to buy the real estate to the seller within the first period of time, or a seller does not accept a presented offer within the first period of time, then presenting the real estate for sale to investors in the second tier for a second period; if an investor in the second tier does not present an offer to buy the real estate to the seller within the second period, or a seller does not accept an offer within the second period, then presenting the real estate for sale to investors in the third tier for a third period.

### FIELD OF THE INVENTION

The present invention relates broadly to real estate transactions, and more specifically to matching investors with sellers of real estate properties.

### BACKGROUND OF THE INVENTION

Real estate remains a primary asset for many people and institutions. While real estate can be a profitable investment vehicle, and it is easy acquire real estate, selling real estate quickly remains a challenge. Typically, a seller of real estate places a property on a multiple listing service and waits for a buy to make an offer, and often a lengthy period is involved to transact the sale of the property. However, a seller sometimes finds himself or herself in need of cash, or the property has become too burdensome to retain, and the lengthy period of a typical real estate listing and sale is undesirable from a cost and time standpoint. Furthermore, some real estate investors are focused on finding and acquiring distressed properties to buy, but this is a challenge because the typical multiple listing service doesn't accurately reflect the distressed nature of a property, as sellers often do not wish to publicly announce that their property is distressed, and such investors generally have to watch for foreclosures, which many sellers seek to avoid.

### SUMMARY OF THE INVENTION

In one aspect, the present invention provides a method for selling real estate, including: organizing prospective buyers into one of a first tier of investors, a second tier of investors, and a third tier of investors; presenting real estate for sale only to investors in the first tier, wherein the real estate presented for sale is presented for a first period of time when a seller first decides to offer the real estate for sale; if an investor in the first tier does not present an offer to buy the real estate to the seller within the first period of time, or a seller does not accept a presented offer within the first period of time, then presenting the real estate for sale to investors in the second tier for a second period of time; if an investor in the second tier does not present an offer to buy the real estate to the seller within the second period of time, or a seller does not accept an offer within the second period of time, then presenting the real estate for sale to investors in the third tier for a third period of time.

In an embodiment, an investor in the first tier makes an offer to the seller without requiring any repair or modification to the real estate for sale. In an embodiment, the offer from an investor in the first tier comprises a guaranteed offer. In an embodiment, the offer from an investor in the first tier comprises an instant offer. In an embodiment, the first period of time is a period of time in which an investor in the first tier negotiates a sales price, opens escrow, and sets a closing date. In an embodiment, investors in the first tier pay an exclusive access fee to receive real estate offers for sale during the first period of time. In an embodiment, investors in the second tier pay an access fee to receive real estate offers for sale during the second period of time. In an embodiment, investors in the third tier pay an access fee to receive real estate offers for sale during the third period of time. In an embodiment, investors in the first, second and third tiers pay a buyers commission when they successfully purchase real estate from a seller. In an embodiment, the seller pays a sellers commission if the real estate is sold to a third tier investor. In an embodiment, presenting real estate for sale to investors in the third tier comprises auctioning the real estate to investors in the third tier. In an embodiment, an investor is admitted to the first tier, second tier, or third tier only upon showing ownership or control of a predetermined amount of assets.

In another aspect, the present invention provides a system for matching buyers and sellers of real estate, including: a database of prospective buyers organized into one of a first tier of investors, a second tier of investors, and a third tier of investors; a database of sellers of real estate; a communication module configured to facilitate real estate sales transactions over a computer network between the prospective buyers and sellers of real estate and to present real estate for sale only to investors in the first tier, wherein the real estate presented for sale is presented for a first period of time when a seller first decides to offer the real estate for sale, and if an investor in the first tier does not present an offer to buy the real estate to the seller within the first period of time, or a seller does not accept a presented offer within the first period of time, then presenting the real estate for sale to investors in the second tier for a second period of time, and if an investor in the second tier does not present an offer to buy the real estate to the seller within the second period of time, or a seller does not accept an offer within the second period of time, then presenting the real estate for sale to investors in the third tier for a third period of time; and a payment module configured to facilitate payment of money from a buyer to a seller when a real estate transaction is conducted.

In an embodiment, a first user interface for investors is provided as a downloadable app from the system of the present invention. In an embodiment, a second user interface for sellers is provided as a downloadable app from the system of the present invention.

Many additional features and advantages of the present invention will be apparent from reading the following detailed description of the preferred embodiment, when considered in conjunction with the accompanying drawings, in which:

### BRIEF DESCRIPTION OF THE DRAWINGS

FIG. 1 shows a sequence of operational steps performed in accordance with the present invention for a first tier of investors.

FIG. 2 shows a sequence of operational steps performed in accordance with the present invention for a second tier of investors.

FIG. 3 shows a sequence of operational steps performed in accordance with the present invention for a third tier of investors.

FIG. 4 shows an exemplary user interface for investors using the system of the present invention.

FIG. 5 shows an exemplary user interface for sellers using the system of the present invention.

FIG. 6 shows an exemplary client-server computer architecture of the system of the present invention.

### DETAILED DESCRIPTION

First Tier Buyers

Buyers in the first tier are referred to herein as first mover investors. Investors in this category are provided exclusive access to off-market real estate opportunities as soon as listings are approved and entered into the system of the present invention for a period of time.

All first mover investors are prequalified buyers. First mover investors can be qualified purchasers, being either individuals or institutional purchasers, or an accredited investor. First mover investors can purchase properties by making a first offer. A first offer includes fast offers, which occur within a preset time period, guaranteed offers, instant offers that are preset by a first mover investor to be made automatically upon a property being offered, pre-auction bids, highest bids, Buy It Now selections, and the like. First mover investors thus get first dibs on all new or incoming real estate listings for a defined period of time to make offers to the seller, negotiate sales price, finalize terms, sign contracts, open escrow and set closing dates. First mover investors pay an exclusive access fee for first dibs rights.

The system of the present invention, in an embodiment, implements a PreMarketplace that runs a series of promotions to sell a property as quickly as possible by creating a pre-auction and auction process for the sale of the property and/or simultaneously listing the property for sale (such as through Buy It Now transactions) through a traditional brokerage/listing/agency service. First mover investors pay a buyer's commission, for example, up to 6% of the purchase price of a property. Additional investor terms may be applied and/or changed at later date and/or during ongoing business operations.

In an embodiment, a seller's property is not listed on the open market through traditional real estate broker accessed multiple listing services or through any publicly accessible real estate listings. Properties for sale are only available for search and purchase through the system of the present invention for first mover investors.

To facilitate fast sales of properties, the seller is not required to fix, repair, or renovate their property in order to sell. In an embodiment, sellers pay a seller's commission between 0% and 6%.

Second Tier Buyers

Buyers in the second tier are referred to herein as preferred investors. All preferred investors are prequalified buyers. If Seller's property does not sell in the first period to first mover investors or the Seller does not accept any offers during the first time period exclusively available to first mover investors, then the property is offered for sale to a second tier of buyers.

Like the first tier of first mover investors, preferred investors in the second tier include qualified purchasers, either individual or institutional, accredited investors, but also nonaccredited investors. Like first mover investors in the first tier, preferred investors in the second tier can make second offers to a seller. Second offers are similar to first offers described above, and include fast offer, guaranteed offers, instant offers, pre-auction bids, highest bids, Buy It Now offers, and the like.

Investors get second dibs on all real estate listings after the first tier's period has expired, and have another period of time to make offers to the seller, negotiate sales price, finalize terms, sign contracts, open escrow and set closing dates. Like first mover investors of the first tier, preferred investors of the second tier pay a premium access fee for second dibs rights.

The PreMarketplace described above may also run a series of promotions to preferred investors in the second tier to get the property sold as quickly as possible by creating a pre-auction and auction process for the sale of the property and/or simultaneously listing the property for sale (aka: “Buy It Now,” etc.) through a traditional brokerage/listing/agency service. Like first mover investors of the first tier, preferred investors of the second tier pay a buyer's commission, for example up to 6%. Additional investor terms may be applied and/or changed at later date and/or during ongoing business operations.

In an embodiment, during this second period of offering a seller's property to preferred investors, the property is not listed on the open market through traditional real estate broker accessed multiple listing services or through any publicly accessible real estate listings. Properties for sale are only available for search and purchase through the system of the present invention for first mover investors.

To facilitate fast sales of properties, the seller is not required to fix, repair, or renovate their property in order to sell. In an embodiment, sellers pay a seller's commission between 0% and 6%.

If Seller's property does not sell or the seller does not accept any offers in this second time period where the property is offered to a second tier of preferred investors, then the property is offered to a third tier of buyers.

Third Tier Buyers

The third tier of buyers referred to herein includes general investors. Buyers in this category are prequalified retail customers; they are general buyers/investors who are provided two different timeframes of access based on their particular type of member accounts, either limited or unlimited accounts. General investors with limited accounts have access to PreMarketplace offerings and general investors with without accounts are referred to herein as unlimited general investors who have access to Marketplace offerings. All general investors have access to real estate opportunities at this stage if the seller did not accept any offers from buyers in the first and second tiers during the first and second periods. At this point, real estate opportunities will be available to all investor types in the third tier during third and fourth time periods. The third and fourth time periods can be significantly longer than the first and second time periods.

For limited accounts, access to property listings is provided to registered general investors having member accounts with limited access to off-market real estate opportunities in the third period immediately after the first and second time periods for a limited time period and before these opportunities are finally made available in an open marketplace during a fourth period. After the first mover investor and preferred investor categories of the first and second tiers, general investors are able to search and purchase real estate properties solely through the system of the present invention for a limited time period and nowhere else. These opportunities are not made available on any real estate broker access multiple listing services or through any publicly accessible real estate listings.

Like the second tier of preferred investors, general investors in the third tier include qualified purchasers, either individual or institutional, accredited investors, and nonaccredited investors. Like first mover investors in the first tier and preferred investors in the second tier, general investors can make third offers to a seller. Third offers are similar to first and second offers described above, and include fast offer, guaranteed offers, instant offers, pre-auction bids, highest bids, Buy It Now offers, and the like.

General investors get third dibs on all real estate listings (after the 1st tier and 2nd tier) for a period of time to make offers to the Seller, negotiate sales price, finalize terms, sign contracts, open escrow and set closing dates.

Unlike first mover investors and preferred investors, general investors to pay no premium access fee for third dibs rights. However, in an embodiment, general investor limited buyers have registered member accounts to access off-market real estate opportunities for a limited period of time.

The PreMarketplace described above may also utilize the system of the present invention running a series of promotions to preferred investors in the second tier to get the property sold as quickly as possible by creating a pre-auction and auction process for the sale of the property and/or simultaneously listing the property for sale (aka: “Buy It Now,” etc.) through a traditional brokerage/listing/agency service. Like first mover investors of the first tier, preferred investors of the second tier pay a buyer's commission, for example up to 6%. Additional investor terms may be applied and/or changed at later date and/or during ongoing business operations

Seller pays a seller's commission of up to 6%. If the seller doesn't accept any offers in the third period of offerings to limited accounts, then the property is offered in the marketplace to unlimited accounts for sale.

Unlimited general investors have access to properties listed for sale in the marketplace and have unlimited access to real estate opportunities after the first mover investors, preferred investors, and general investor limited periods have completed and until the property sells or until the exclusive listing agreement period expires. In this final phase, real estate opportunities are made available for search and purchase on system of the present invention as well as on real estate broker access multiple listing services and through any publicly accessible real estate listings.

In an embodiment, an individual qualified purchaser is a natural person who owns at least $5 million in investments, including investments (i) held in an IRA or similar account, the investments of which are directed by and held for the benefit of such person, (ii) held jointly with a spouse or (iii) in which such person shares a community property or similar shared ownership interest with a spouse. Spouses who subscribe jointly may combine their investments for purposes of meeting the $5 Million threshold, whether or not the investments are held jointly or individually.

In an embodiment, an institutional qualified purchaser is an entity directly or indirectly owned entirely by two or more closely related natural persons, their estates or foundations, charities or trusts formed by or for their benefit (a “Family Company”) that owns at least $5 million in investments. An institutional qualified investor may also be an entity (including self-directed retirement plans) the interests of which are beneficially owned by “qualified purchasers.”

In an embodiment, an investor is any person acting for such person's own account of the accounts of the other “qualified purchasers” that in the aggregate owns and invests on a discretionary basis at least $25 million in investments, excluding (i) private investment funds in existence on Apr. 30, 1996, unless each beneficial owner of such fund on Apr. 30, 1996 that is currently a beneficial owner has consented to such fund's status as a “qualified purchaser” permitted to invest in a category of investment pools that would include the fund, (ii) entities formed for the purpose of investing in the fund, unless each beneficial owner in the entity is a “qualified purchaser” and (iii) pension and other employee benefit plans that allow the beneficiaries to direct the investments of the plans.

In an embodiment, an accredited investor is any natural person, IRA joint tenants or tenants in common who have an individual income in excess of $200,000 in each of the two most recent years of a joint income with that person's spouse in excess of $300,000 in each of those years and have a reasonable expectation of reaching the same income level in the current year.

In an embodiment, an accredited investor is any natural person, IRA joint tenants or tenants in common who have an individual net worth, or together with his or her spouse, have a combined net worth in excess of $1,000,000 excluding the value of the primary residence of the investor, defined for these purposes as the excess of the total assets at fair market value (excluding the indebtedness secured by the primary residence of the Investor up to its fair market value). Any indebtedness incurred within 60 days with respect to the primary residence that exceeds the fair market value of such residence must be included as a liability.

An accredited investor may also be any corporation, partnership or limited liability company not formed for the specific purpose of investing or acquiring this investment, with total assets in excess of $5,000,000.

An accredited investor may also be any corporation, partnership or limited liability company which is NOT an investment vehicle and which has a net worth in excess to $1,000,000, where all underlying equity owners either have an individual net worth, or together with his or her spouse a combined net worth, in excess of $1,000,000, or are entities with a net worth, in excess of $5,000,000.

An accredited investor may also be any corporation, partnership or limited liability company which is an investment vehicle where All underlying equity owners either have an individual net worth, or together with his or her spouse a combined net worth in excess of $1,000,000.

An accredited investor may also be any revocable trust which each grantor has an individual net worth, or together with his or her spouse, have combined net worth in excess of $1,000,000.

An accredited investor may also be any irrevocable trust with total assets in excess of $5,000,000 NOT formed for the specific purpose of acquiring this investment.

An accredited investor may also be any employee benefit plan that has a total assets in excess of $5,000,000.

An accredited investor may also be any self-directed employee benefit plan in which the decision to invest in the strategy was made by a person that has an individual net worth, or together with his or her spouse, has a combined net worth in excess of $1,000,000.

An accredited investor may also be any employee benefit plan whose decision to invest in the strategy is made by a plan fiduciary which is either a bank, savings and loan, insurance company, or registered investment advisor.

An accredited investor may also be any insurance company or bank.

An accredited investor may also be any foundation or charitable organization with net worth in excess of $5,000,000.

An accredited investor may also be a natural person or a company that after entering into the contract has at least $1,000,000 under the management of the investment advisor.

An accredited investor may also be a natural person or a company that has a net worth (together with assets held jointly with a spouse) of more than $2,100,000 excluding the value of the person's primary residence defined for these purposes as the excess of the total assets at fair market value (excluding the indebtedness secured by the primary residence of the Investor up to its fair market value). Any indebtedness incurred within 60 days with respect to the primary residence that exceeds the fair market value of such residence must be included as a liability.

A non-accredited investor is defined herein as an Investor who does not meet the net worth requirements of an accredited investor. For example, a non-accredited investor is an individual who has a net worth of less than $1,000,000 (including spouse) and who earned less than $200,000 annually ($300,000 with spouse) in the last two years.

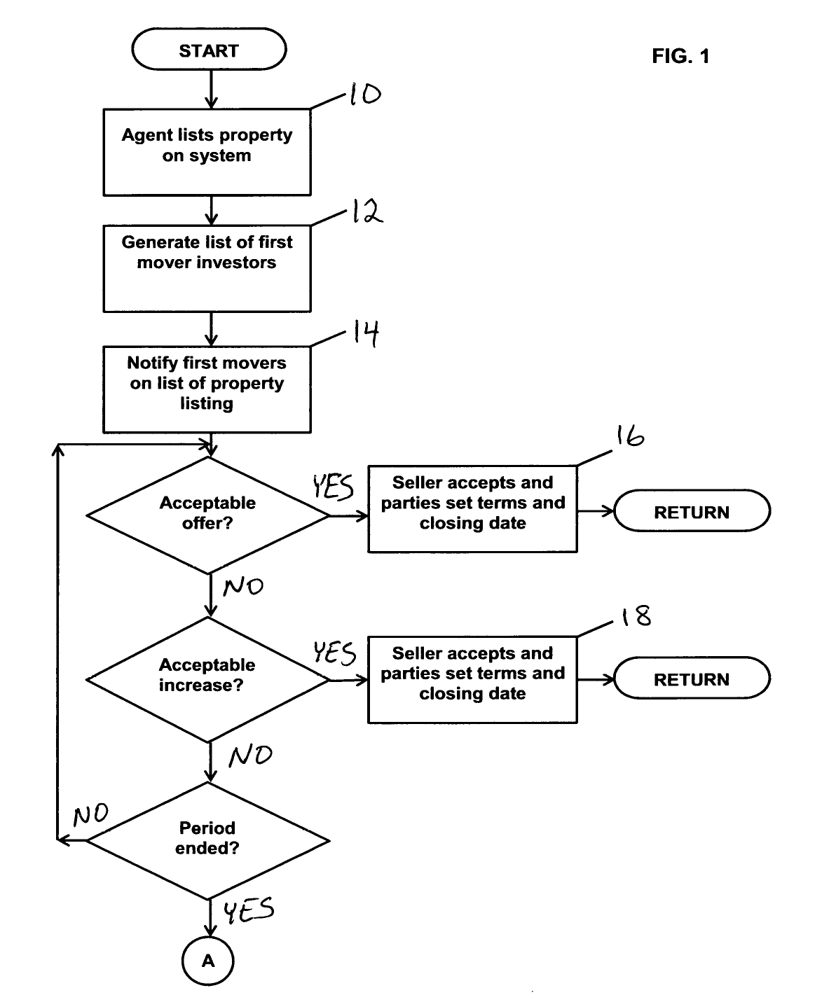

Turning now to FIGS. 1-3, a sequence of operational steps executed in accordance with embodiments of the present invention is now described. As shown in FIG. 1, at step 10, an agent first decides to list a vetted property for sale from the seller on the system of the present invention. At step 12, a list is generated consisting of first mover investors based on investor access tiers and/or a list of investor preferences. At step 14, notifications are sent to first mover investors on the list of real estate opportunities, either electronically or by agents calling them by phone. At step 16, if a first mover investor makes an offer and the seller accepts, then both finalize terms and set a closing date. At step 18, if a first mover investor makes an offer and the seller does not accept, then first mover investor can increase their offer and the seller can accept or reject the higher offer. The seller can receive offers from multiple first mover investors.

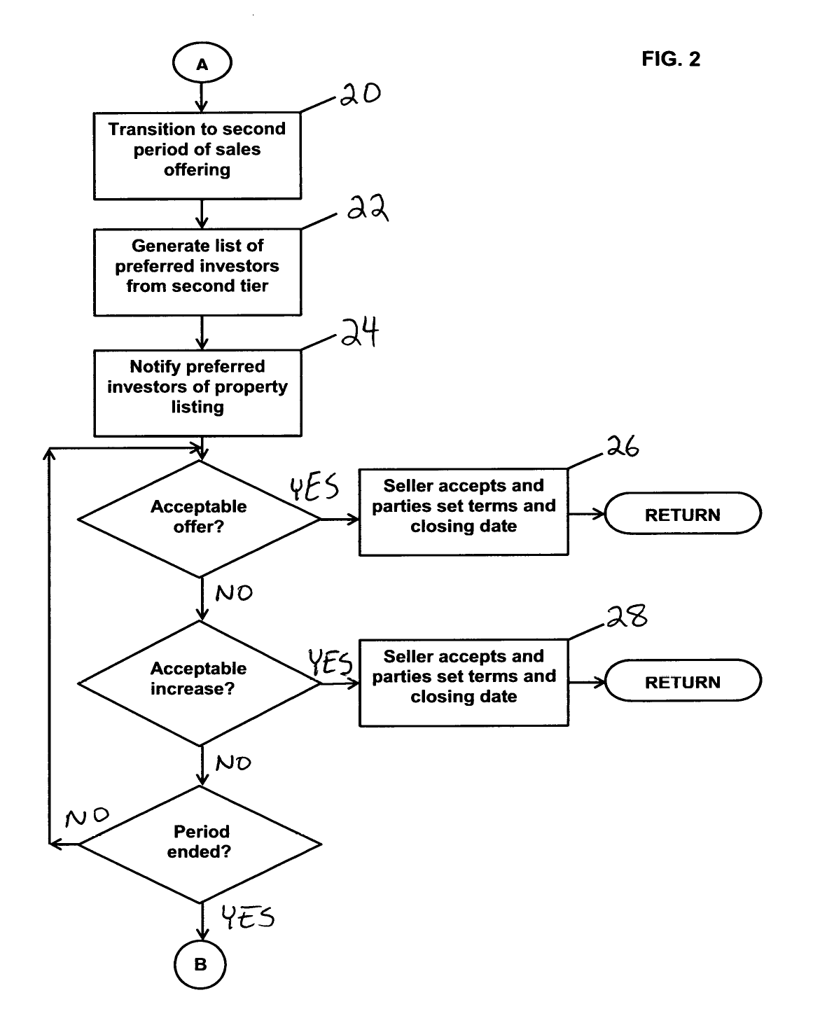

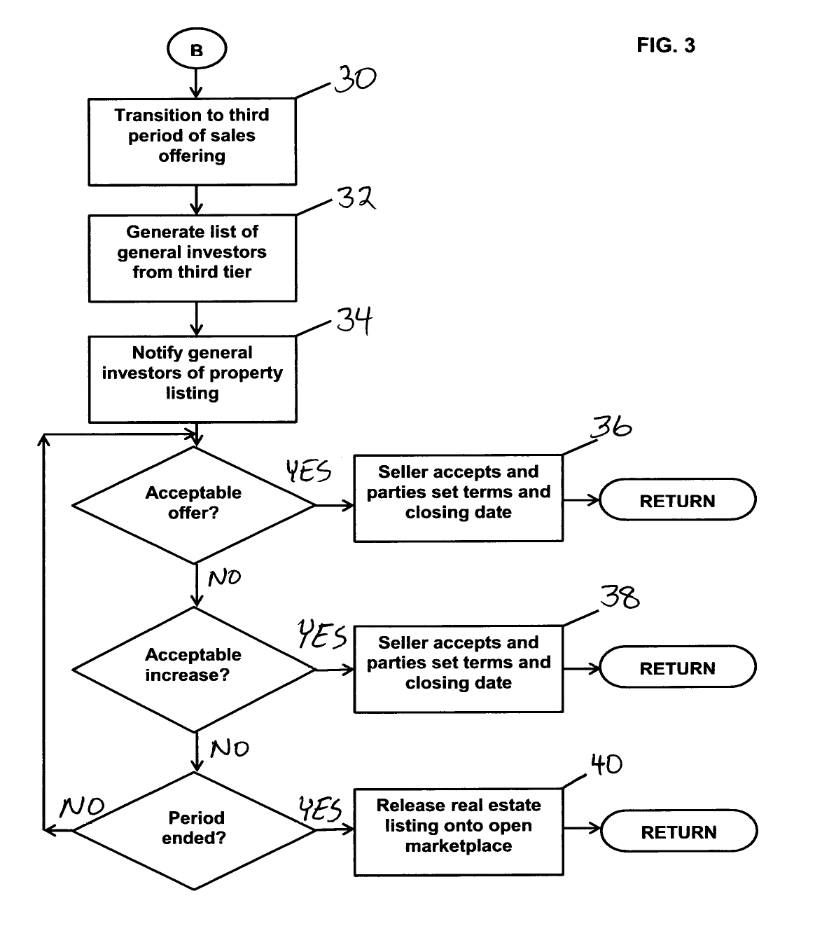

At step 20, if a period of time passes and no first mover investor acts on the investment opportunity or the seller does not accept the first mover investor offers, then the system of the present invention transitions to FIG. 2, and a second period of time in which the seller's real estate property is presented for sale. At step 22, a list is generated consisting of second tier investors (preferred investors) based on investor access tiers and/or a list of investor preferences. In an embodiment, first mover investors are included in this list and are able to participate within this second period. At step 24, notifications are sent to selected preferred investors on the list (and first mover investors from the list generated in step 212 in an embodiment) of real estate opportunities. Notifications can be made electronically or by agents calling them by phone. At step 26, if a preferred investor or first mover investor makes an offer and the seller accepts, then both finalize terms and set a closing date. At step 28, if seller does not accept the offer made at step 26, then the preferred investor (or first mover investor) can increase their offer(s) and the seller can accept or deny the higher offer. The seller can receive offers from multiple preferred investors and first mover investors. As shown in FIG. 3, at step 30, if a period of time passes and no preferred investor or first mover investor acts on the investment opportunity or the seller does not accept an offer, then the system of the present invention transitions to a third period of time in which the seller's real estate property is presented for sale. At step 32, a list of third tier investors is generated including general investors limited and is based on investor access tiers and/or a list of investor preferences. In an embodiment, preferred investors and first mover investors are also be able to participate within this third period. At step 34, notifications are sent to general investors limited in the list generated in step 32, as well as preferred investors and first mover investors described above, of real estate opportunities via electronic messages or agents calling them by phone. At step 36, If the general investor limited, preferred investor or first mover investor makes an offer and the seller accepts, then any of those investors can finalize terms and set a closing date with the seller. At step 38, the general investor limited, preferred investor or first mover investor makes an offer and the seller doesn't accept then a higher offer can be made until the seller accepts. The seller can receive offers from multiple investors. At step 40, after the third period passes without an offer accepted by the seller, the system of the present invention releases the real estate listing onto an open Marketplace for all investors to access; whether registered or unregistered.

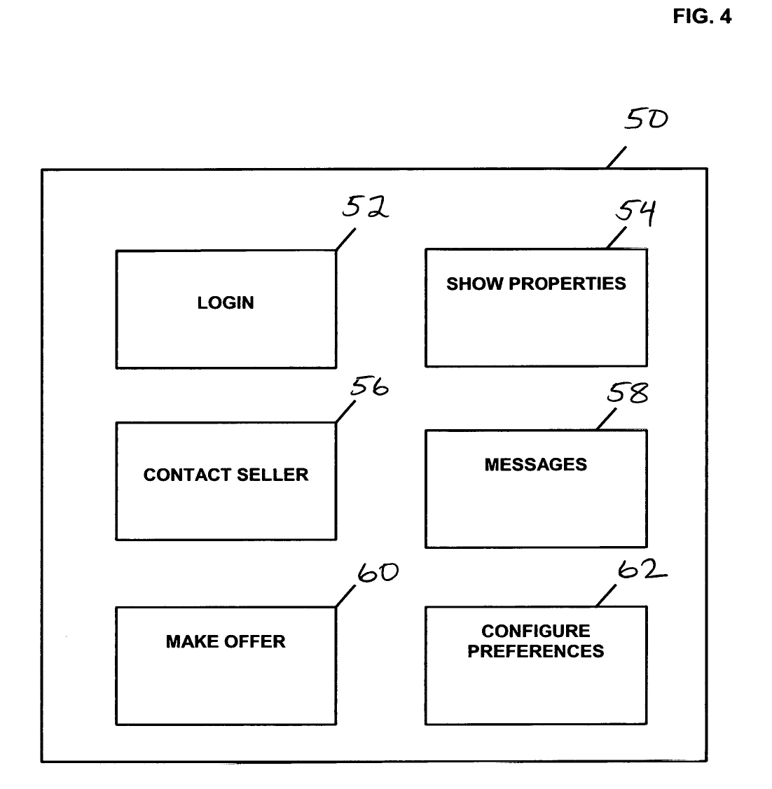

FIG. 4 shows a simple user interface 50 for investors to use for communicating with the system of the present invention. In the preferred embodiment, interface 300 downloaded as an app from the system of the present invention, and is utilized on a computing device maintained by an investor, and can be implemented on a wide variety of electronic devices such as smart phones, notebook computers, laptop computers, and the like, whatever device includes a processor, a display screen, and a communication link to a public communication network such as the Internet. Interface 50 is shown on the screen of investor's computing device, and includes a login button 52, which, when selected, prompts a user to enter a login name and password for secure connection to a remote server on which the system of the present invention is implemented.

Show properties button 54, when selected, displays a list of real estate properties offered for sale to the investor. For example, real estate properties may be displayed in a list by location, value, size, zoned use, date offered for sale, or other attribute related to properties that is of use to investors. Each item listed, when selected, displays more details regarding the property to the user, such as photographs, videos, written description, and the like. Contact seller button 56, when selected, provides a simple messaging interface for a written message to be produced by the investor, such as questions regarding the property, and sent to the seller of the property. Messages button 58, when selected, displays messages received from the seller or other relevant parties. Make offer button 60, when selected, allows an investor to enter a dollar amount to serve as an offer to buy a selected property. In an embodiment, make offer button 310 also provides additional terms to be specified by an investor, such as closing date, inspection reports, requested documentation from the seller, and the like. In an embodiment, make offer button 60 also includes an offer type, such as fast offer, immediate offer, buy it now, and the like.

Configure preferences button 62, when selected, allows an investor to specify user preferences regarding properties that are of interest to the investor as well as detailing any automated bids such as immediate offer, highest bid, and the like. For example, if an investor is only interested in making offers within a range of dollar values or one specific dollar value on condominiums built after 1990 that have two or three bedrooms and are located within a specific zip code or on a specified street, these preferences can be entered by the user upon selecting configure preferences button 62.

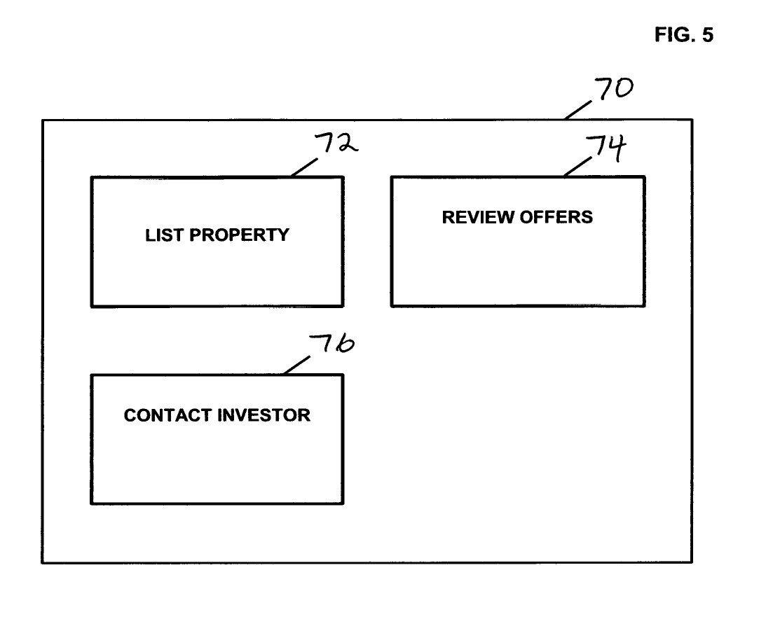

FIG. 5 shows a simple user interface 70 for sellers to use for communicating with the system of the present invention. In the preferred embodiment, interface 70 downloaded as an app from the system of the present invention, and is utilized on a computing device maintained by an investor, and can be implemented on a wide variety of electronic devices such as smart phones, notebook computers, laptop computers, and the like, whatever device includes a processor, a display screen, and a communication link to a public communication network such as the Internet. Interface 70 is shown on the screen of investor's computing device, and includes a login button 72, which, when selected, prompts a user to enter a login name and password for secure connection to a remote server on which the system of the present invention is implemented.

List property button 72, when selected by a seller, allows a user to enter information regarding a real estate property the seller wishes to place up for sale on the system of the present invention to investors utilizing user interface 70. When selected, list property button 72 allows a user to enter information about the property, such as address, size, year built, type of property such as residential or commercial, permits and reports available for inspection, and the like. The seller can also include a written description that provides additional details such as upgrades, orientation of the property within a building, for example windows facing south, what floor the property is located on within a building, reason for selling, and the like. When the description is completed, the property listing is sent to the system of the present invention for review and placement within a database of listings maintained by the system of the present invention.

Review offers button 74, when selected by the seller, presents offers received from investors using interface 70 to communicate with the seller through the system of the present invention. In an embodiment, the offers are presented in the form of a list, each offer in the list being viewable by dollar amount and selectable and further displaying, when selected, details and terms associated with the offer, such as closing date, contingencies such as inspections, and other requirements made by the investor who placed the bid. When an offer is selected from the list, an option is made to accept the offer or reject the offer. In the case of an acceptance, the seller accepts all terms contained in the received offer. In the case of a rejection, in an embodiment, the seller may enter a counteroffer. For example, if an offer received is for less than what the seller will accept, the seller can enter an amount that would be acceptable to the seller, and the investor can accept that counteroffer or place a different offer. Additionally, a rejection may be made based on terms other than price, for example closing date, in which case the seller can indicate a modified term in the rejection and thus reply with a counteroffer to the investor.

Contact investor button 76, when selected by the seller, presents a list of investors who have made offers that are still pending. The seller can select individual investors from the list and send messages directly to them, for example negotiating terms before accepting or rejecting a pending offer. In some embodiments, the contact investor button 76 can be used to answer questions an investor may have, or to ask questions of the investor that the seller may have. When selected, the seller can draft a message and send it electronically through the system of the present invention to an investor.

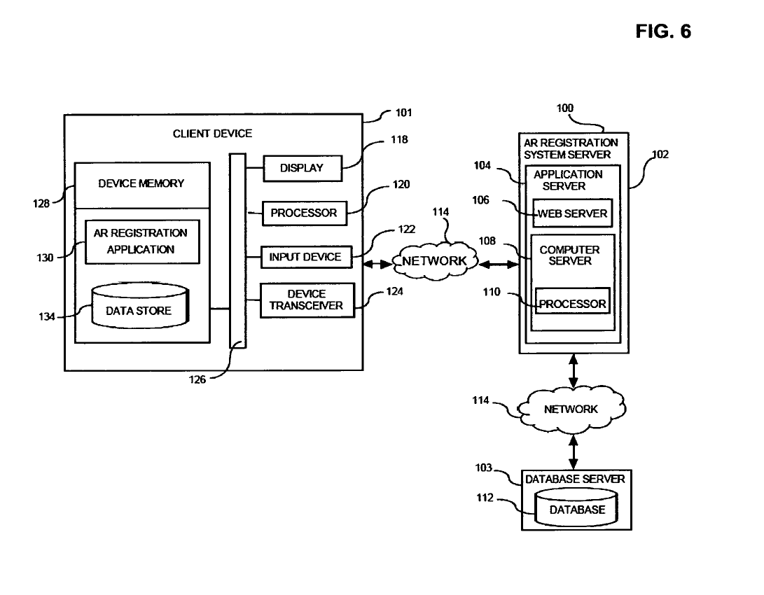

FIG. 6 illustrates the general architecture of a client-server system 100 that operates in accordance with embodiments of the present invention to enable users of the app of the present invention using a client device to communicate with system operators administering a system of server devices. In a preferred embodiment, system 100 is implemented in multi-tier or n-tier architecture with one or more client devices 101, controlled by users residing at the client tier, one or more system servers 102 in the middle or server application tier and one or more database servers 103 residing in the database tier. In the above variant of three-tier architecture the client, the first tier, may have to only perform the user interface i.e., validate inputs; in which case the middle tier holds all the backend logic and does data processing while the data server, the third tier, performs data validation and controls the database access.

One or more client devices 101 are connected to access request (AR) system server 102 via a network 114. The system server 102 communicates with the client devices 101 over the network 114 to present a user interface or graphical user interface (GUI) for system 100 of the present invention. The user interface of system 100 of the present invention can be presented through a web browser or through a mobile application communicating with the system server 102 and is used for displaying, entering, publishing, and/or managing data required for the service. As used herein, the term “network” generally refers to any collection of distinct networks working together to appear as a single network to a user. The term also refers to the so-called world wide “network of networks” or Internet which is connected to each other using the Internet protocol (IP) and other similar protocols. As described herein, the exemplary public network 114 of FIG. 1 is for descriptive purposes only and it may be wired or wireless. Although the description may refer to terms commonly used in describing particular public networks such as the Internet, the description and concepts equally apply to other public and private computer networks, including systems having architectures dissimilar to that shown in FIG. 1. The inventive idea of the present invention is applicable for all existing cellular network topologies or respective communication standards, in particular GSM, UMTS/HSPA, LTE and the like. With respect to the present description, the system server 102 may include any service that relies on a database system that is accessible over a network, in which various elements of hardware and software of the database system may be shared by one or more users of system 100. To this end, the users of the client device 101, from which a request or instruction is received over a network 114, may include any individual customer. The GUI or user interface provided by the system server 102 on the client devices 101 through a web browser or mobile app may be utilized by the users for utilizing system 100 to buy and sell invoices on system server 102.

The components appearing in the server 102 refer to an exemplary combination of those components that would need to be assembled to create the infrastructure in order to provide the tools and services contemplated by the present invention. As will be apparent to one skilled in the relevant art(s), all of components “inside” of the server 102 may be connected and may communicate via a wide or local area network (WAN or LAN).

Server 102 includes an application server or executing unit 104. The application server or executing unit 104 comprises a web server 106 and a computer server 108 that serves as the application layer of the present invention. The web server 106 is a system that sends out web pages, such as screens 1-5 described above, containing electronic data files in response to Hypertext Transfer Protocol (HTTP) requests from remote browsers (i.e. browsers installed in the client devices 101) or in response to similar requests made through a mobile app or mobile application of the present invention installed on a client device 101. The web server 106 can communicate with the mobile app of the present invention and/or with a web browser installed on a client device 101 to provide the user interface required for the service.

The computer server 108 may include a processor 110, a random access memory (RAM) (not shown in figures) for temporary storage of information, and a read only memory (ROM) (not shown in figures) for permanent storage of information. Computer server 108 may be generally controlled and coordinated by operating system software. The operating system controls allocation of system resources and performs tasks such as processing, scheduling, memory management, networking, and I/O services, among (other) things. Thus, the operating system resides in system memory and, on being executed by a processor such as a CPU, coordinates the operation of the other elements of system server 102.

Although the description of the computer server 108 may refer to terms commonly used in describing particular computer servers, the description and concepts equally apply to other processing systems, including systems having architectures dissimilar to that shown in FIG. 1.

The database tier is the source of data where at least one database server 103 generally interfaces multiple databases 112. Those databases are frequently updated by their users and administrators most often through a combination of private and public networks 114 including the Internet. It would be obvious to any person skilled in the art that, although described herein as the data being stored in a single database, different separate databases can also store the various data and files of multiple users.

A mobile application, or “app” as described above, is a computer program that may be downloaded and installed in client device 101 using methods known in the art. Hereinafter, the mobile app 130 is referred to as Access Request (AR) app 130. App 130, custom built for the present invention, enables one or more persons to view screens 1-5 described above and to do various tasks related to functions of system server 102 described above. The activities related to the service of the present invention can also be performed using the user interface (or GUI) presented through a client device based web browser. Hereinafter, the term “user interface” is used to refer to both app user interface and the web browser user interface of the present invention, and is illustrated in FIGS. 2 and 3. Examples of client device 101 may include, but not limited to, mobile devices, tablets, hand-held or laptop devices, smart phones, personal digital assistants, desktop computers, or any similar device.

As illustrated in FIG. 4, the client device 101 may include various electronic components known in the art for this type of device. In this embodiment, the client device 101 may include a device display 118, a computer processor 120, a user input device 122 (e.g., touch screen, keyboard, microphone, and/or other form of input device known in the art), a device transceiver 124 for communication, a device memory 128, the AR app 130 operably installed in the computer memory 128, a local data store 134 also installed in the device memory 128, and a data bus 126 interconnecting the aforementioned components. For purposes of this application, the term “transceiver” is defined to include any form of transmitter and/or receiver known in the art, for cellular, WIFI, radio, and/or other form of wireless or wired communication known in the art. Obviously, these elements may vary, or may include alternatives known in the art, and such alternative embodiments should be considered within the scope of the claimed invention.

What is claimed is:

1. A method for selling real estate, comprising:
organizing prospective buyers into one of a first tier of investors, a second tier of investors, and a third tier of investors;
presenting real estate for sale only to investors in the first tier, wherein the real estate presented for sale is presented for a first period of time when a seller first decides to offer the real estate for sale;
if an investor in the first tier does not present an offer to buy the real estate to the seller within the first period of time, or a seller does not accept a presented offer within the first period of time, then presenting the real estate for sale to investors in the second tier for a second period of time;
if an investor in the second tier does not present an offer to buy the real estate to the seller within the second period of time, or a seller does not accept an offer within the second period of time, then presenting the real estate for sale to investors in the third tier for a third period of time.

2. The method of claim 1, wherein the offer is characterized by the absence of a requirement of any repair or modification to the real estate for sale.

3. The method of claim 1, wherein the offer from an investor in the first tier comprises a guaranteed offer.

4. The method of claim 1, wherein the offer from an investor in the first tier comprises an instant offer.

5. The method of claim 1, wherein the first period of time comprises a period of time in which an investor in the first tier negotiates a sales price, opens escrow, and sets a closing date.

6. The method of claim 1, wherein investors in the first tier pay an exclusive access fee to receive real estate offers for sale during the first period of time.

7. The method of claim 1, wherein investors pay an access fee to receive real estate offers for sale during the second period of time.

8. The method of claim 1, wherein investors pay a buyers commission when they successfully purchase real estate from a seller.

9. The method of claim 1, wherein the seller pays a sellers commission if the real estate is sold to an investor.

10. The method of claim 1, wherein presenting real estate for sale comprises auctioning the real estate to investors.

11. The method of claim 1, wherein an investor is admitted to the first tier, second tier, or third tier only upon showing ownership or control of a predetermined amount of assets.

12. A system for matching buyers and sellers of real estate, comprising:
a database of prospective buyers organized into one of a first tier of investors, a second tier of investors, and a third tier of investors;
a database of sellers of real estate;
a communication module configured to facilitate real estate sales transactions over a computer network between the prospective buyers and sellers of real estate and to present real estate for sale only to investors in the first tier, wherein the real estate presented for sale is presented for a first period of time when a seller first decides to offer the real estate for sale, and if an investor in the first tier does not present an offer to buy the real estate to the seller within the first period of time, or a seller does not accept a presented offer within the first period of time, then presenting the real estate for sale to investors in the second tier for a second period of time, and if an investor in the second tier does not present an offer to buy the real estate to the seller within the second period of time, or a seller does not accept an offer within the second period of time, then presenting the real estate for sale to investors in the third tier for a third period of time; and
a payment module configured to facilitate payment of money from a buyer to a seller when a real estate transaction is conducted.
